(19) United States
(12) Patent Application Publication
(10) Pub. No.: US 2007/0261494 A1
(43) Pub. Date: Nov. 15, 2007

(54) ULTRASONIC TRANSDUCER DEVICES AND DETECTION APPARATUS

(75) Inventors: William R. Fuller, Chagrin Falls, OH (US); Daniel N. Kelsch, Fairview Park, OH (US); Jan J. Lewandowski, South Euclid, OH (US); Grazyna Palczewska, Bay Village, OH (US); Alexander K. Smith, Newton Falls, OH (US)

Correspondence Address: PEARNE & GORDON LLP, 1801 EAST 9TH STREET, SUITE 1200, CLEVELAND, OH, 44114-3108, US

(73) Assignee: BIOMEC, INC., Cleveland, OH (US)

(21) Appl. No.: 11/696,036

(22) Filed: Apr. 3, 2007

Related U.S. Application Data
(60) Provisional application No. 60/745,961, filed on Apr. 28, 2006.

(51) Int. Cl. G01N 29/04

(52) U.S. Cl. 73/620; 600/459

(57) ABSTRACT

Detection apparatus can include a positioning device with a wall including a substantially conical inner surface and a detection device configured to send and receive signals and move along the conical inner surface. Detection apparatus are also provided that comprise a positioning device and an end portion with an image port, a light device, and a detection device configured to send and receive signals. Ultrasonic transducer devices are also provided with a transducer material layer, a contact plating layer including a convex portion with an array of transducer elements, an acoustic matching layer, and a top plating layer.

### CROSS-REFERENCE TO RELATED APPLICATIONS

This application claims the benefit of U.S. Provisional Application No. 60/745,961, filed Apr. 28, 2006, the entire disclosure of which is hereby incorporated herein by reference.

### FIELD OF THE INVENTION

The present invention relates to ultrasonic transducer devices and detection apparatus, and more particularly, to ultrasonic transducer devices and detection apparatus for use in an ear environment of an organism.

### BACKGROUND OF THE INVENTION

Ear disorders are common afflictions affecting many people and animals. For example, otitis media (OM), such as acute otitis media (AOM), an inflammatory process of the middle ear, is the most common clinical condition seen by pediatricians in children 15 years old and younger. OM is characterized by the presence of middle ear effusion (MEE), a middle ear fluid. Complications of undiagnosed OM can include hearing loss and consequently delay in the development of speech and language skills. The combination of the gravity of the complications of undiagnosed OM and unsatisfactory diagnostic techniques often leads to unnecessary over prescription of medication with antibiotics.

The most reliable determination of the presence of MEE is direct surgical exploration (tympanocentesis). This can be accomplished by making a needle puncture in the eardrum (tympanic membrane) followed by fluid aspiration. It is an invasive procedure and does not provide an acceptable standard of care. None of the existing non-invasive methods for determining the presence of MEE achieve 100% agreement with tympanocentesis. In order to reduce unnecessary antibiotic use and assuring at the same time effective and complication-free treatment of patients with OM, there is an urgent need to develop a simple but more accurate method for non-invasive MEE detection.

### BRIEF SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

In accordance with one aspect of the present invention, a detection apparatus comprises a positioning device including a wall with a substantially conical inner surface. The detection apparatus further includes a detection device configured to send and receive signals and move along the conical inner surface of the wall between a retracted position and a detection position.

In accordance with another aspect of the present invention, an ultrasonic transducer device comprises a transducer material layer with a convex surface and a concave surface. The ultrasonic transducer device further includes a contact plating layer including a convex portion with an array of transducer elements, wherein the convex portion of the contact plating layer is disposed on the concave surface of the transducer material layer. The ultrasonic transducer device further includes an acoustic matching layer including a convex surface facing away from the transducer material layer and a concave surface facing towards the transducer material layer. The ultrasonic transducer device also includes a top plating layer at least partially disposed between the convex surface of the transducer material layer and the concave surface of the acoustic matching layer.

In accordance with yet another aspect of the present invention, a detection apparatus comprises a positioning device with a substantially conical outer surface and an end portion. The end portion is provided with an image port, a light device, and a detection device configured to send and receive signals. The detection apparatus further includes an electronic view screen configured to display images based on information from the image port.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a side view of detection apparatus in accordance with aspects of the present invention;

FIG. 2 illustrates a perspective view of an ultrasonic transducer in accordance with aspects of the present invention;

FIG. 3 illustrates a rear view of the ultrasonic transducer of FIG. 2;

FIG. 4 illustrates a cross sectional side view of the ultrasonic transducer along line 4-4 of FIG. 3;

FIG. 4A is an enlarged view of a portion of the ultrasonic transducer of FIG. 4;

FIG. 5 illustrates a representational sectional view of portions of the ultrasonic transducer;

FIG. 6 illustrates a methodology for manufacturing an ultrasonic transducer in accordance with aspects of the present invention;

FIG. 7 illustrates the detection apparatus of FIG. 1 used in an ear environment in accordance with aspects of the present invention;

FIG. 8 illustrates a control system for a detection apparatus in accordance with aspects of the present invention;

FIG. 9A illustrates a side view of another detection apparatus in accordance with aspects of the present invention, wherein portions of a positioning device are illustrated in cross section;

FIG. 9B is a partial sectional view of the detection apparatus of FIG. 9A along line 9B-9B of FIG. 9A;

FIG. 10 illustrates a side view of another detection apparatus in accordance with aspects of the present invention, wherein portions of a positioning device are illustrated in cross section;

FIG. 11 is a sectional perspective view of a positioning device in accordance with further aspects of the present invention;

FIG. 12 is a perspective view of another detection apparatus in accordance with further aspects of the present invention;

FIG. 13 is an end perspective view of an end portion of the detection apparatus of FIG. 12;

FIG. 14 illustrates the detection apparatus of FIGS. 9A and 9B in an observation position;

FIG. 15 illustrates the detection apparatus of FIGS. 9A and 9B providing fluid to the ear canal;

FIG. 16 illustrates the detection apparatus of FIGS. 9A and 9B wherein the detection device is being moved to a detection position; and

FIG. 17 illustrates the detection apparatus of FIGS. 9A and 9B conducting a detection operation.

### DESCRIPTION OF EXAMPLE EMBODIMENTS

Examples of the present invention can be carried out with features disclosed and described in U.S. Pat. No. 7,131,946, filed Dec. 5, 2003 and United States Patent Application Publication No. 2004/0138561 filed Dec. 5, 2003, the references which are entirely incorporated herein by reference.

The present invention relates to ultrasonic transducers, detection apparatus and methods of using detection apparatus. While reference is made for use in detecting conditions of human beings, it is understood that the transducers, apparatus and methods herein may be used to detect ear conditions of dogs, cats or other animals. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components may be drawn to facilitate the understanding of the drawings. In the following description, for purposes of explanation, numerous specific details are set forth in order to provide a thorough understanding of the present invention. It may be evident, however, that the present invention can be practiced without these specific details.

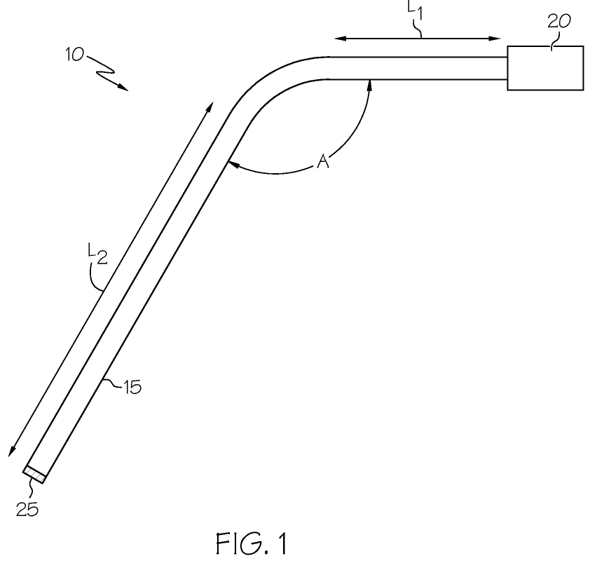

Turning initially to FIG. 1, an example of a detection apparatus 10 is illustrated in accordance with aspects of the present invention. The detection apparatus 10 includes a probe 15 that is configured to interact with an object to detect information about a feature of the object, such as flaws or irregularities. For instance, as will be explained in greater detail below, the detection apparatus can be adapted to interact with an ear to detect MEE. The probe 15 can be of any desired shape, length, and dimension depending upon the intended use of the probe 15. As shown in FIG. 1, the probe 15 is presented as being generally cylindrical in shape with a generally circular cross section. Although not shown, the probe can include other cross sectional shapes such as a polygonal shape with three or more sides, an elliptical shape or other shape. As further illustrated, the probe can have a single bend along an axis of the probe. In further examples, the probe can be substantially straight or can have a plurality of bends along the axis of the probe. The bend, if provided, can form an angle A that is greater than 90-degrees and less than 180-degrees. In one example, the probe 15 can include a bend forming an angle of about 120-degrees. If provided with a single bend, the probe can be effectively divided into two different lengths, L₁ and L₂ extending along the axis of the probe. In example embodiments, L₁ and L₂ can each be between about 25 mm and about 150 mm in length. In further example embodiments, L₁ can be about 50 mm in length and L₂ can be about 100 mm in length.

In example embodiments, a maximum outer dimension of a cross section transverse the axis of the probe 15 is less than 5 mm. In examples where the cross section is generally circular in shape, the outer dimension comprises the diameter D₁ of the probe 15 as shown in FIG. 5. In such examples, the diameter D₁ of the probe 15 can be less than 5 mm. In further examples, the outer dimension of the cross section transverse the axis of the probe 15 (e.g., the diameter D₁ of the probe) is less than 2 mm. It is to be appreciated that the probe 15 can be configured with any shaped cross section (e.g., round, square, triangular, elliptical) with any number of bends, including none, forming any sized angle, and can be of any suitable length and diameter and is contemplated as falling within the scope of the present invention. The configuration of the probe 15 can be chosen based on the intended use of the probe.

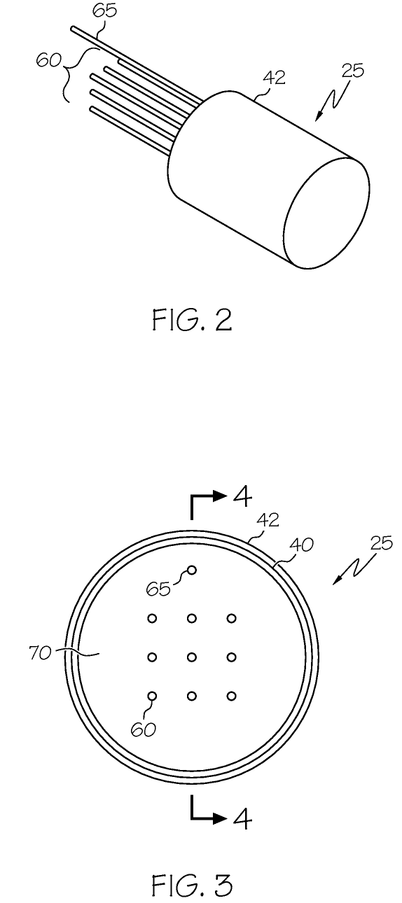

One end of the probe 15 can be coupled to a connector 20 configured to couple the probe 15 to a controller connection (not shown) via a cable (not shown) or the like. The other end of the probe 15 can include a detection device configured to send and receive signals. A wide variety of detection devices may be provided in accordance with aspects of the present invention. For instance, as shown, the detection device can comprise an ultrasonic transducer 25 attached to a distal end of the probe 15. Different types and configurations of ultrasonic transducers may be incorporated in accordance with aspects of the present invention. In one example, the face of the ultrasonic transducer 25 can be spherically convex in shape. FIGS. 2-5 illustrate one example of an ultrasonic transducer 25 that may be incorporated as part of the detection apparatus 10. Although the ultrasonic transducer 25 is illustrated a part of the detection apparatus 10 illustrated and described with respect to FIG. 1, it is understood that similar or identical transducers may be used as part of other detection apparatus, for example, described and illustrated throughout this application. Moreover, the ultrasonic transducer 25 may have different shapes and sizes. In one example, the transducer may be longer in size or may be integral with the probe 15 in further examples.

The ultrasonic transducer 25 can include one or a plurality of sensors supported thereon. In one example, the one or plurality of sensors can comprise one or more ultrasonic transducer elements 30 although other sensor types may be incorporated in further aspects of the present invention. Any number of transducer elements may be utilized. For example, as shown in FIG. 5, the ultrasonic transducer 25 can include nine transducer elements 30 arranged in a 3×3 array 35.

In the illustrated example, each ultrasonic transducer element 30 comprises an ultrasonic transceiver configured to transmit and receive ultrasonic signals (e.g., wave beams). Specifically, each transducer element 30 can be configured to transmit an ultrasonic signal and receive the ultrasonic signal that is reflected back to the transducer element 30. For each transducer element 30, the output of an ultrasonic signal can be generated by applying an electrical stimulus signal, and the receipt of the reflected signal results in a return signal. The operation of each transducer element 30 to output the associated signal can be referred to as “firing.”

Various types of transducer elements may be incorporated in accordance with aspects of the present invention. For example, transducer elements that operate at higher frequencies may be used in applications where enhanced resolution is desired. However, higher frequencies can result in lower penetration than lower frequencies. On the other hand, transducer elements that operate at lower frequencies may be used in applications where higher penetration is desired. However, lower frequencies can result in lower resolution. In one example, each transducer element 30 can have a center frequency of under 100 MHz (i.e., the output signal can have such a frequency). For instance, in detecting MEE, high frequencies can be used to distinguish between different types of fluid behind the membrane and between reflections from different interfaces within the ear. In further examples, the transducer elements 30 can have a frequency of between about 1 MHz and about 50 MHz. In further examples, the transducer elements 30 can have a frequency of about 20 MHz. Providing the transducer elements 30 with a frequency of 20 MHz can provide a desirable tradeoff between the penetration and resolution of various ear geometries. The transducer elements 30 may be made from known materials and by known methods. However, newly developed materials and methods may be used.

Each reflected signal that is received can convey information (e.g., data) concerning the surface(s) from which the signal was reflected. Upon interaction of the probe 15 and the object being interrogated, signals from the transducer elements 30 can be reflected from surfaces on or within the object. For example, when used in an ear, the signals may reflect from one or more interfaces within the ear, such as the tympanic membrane within the ear. As an example of the information conveyed via the reflected signals, amplitude(s) and/or frequency spectrum(s) of the reflected signals can be used to predict a fluid state within a middle ear portion of the ear. Such fluid state within the middle ear can be associated with an ear disorder. For example, in the case of effusion, a second echo reflected from the middle ear cavity may provide information concerning an ear disorder.

If provided as a plurality of transducer elements 30, the transducer elements 30 on the probe 15 can be arranged in an array 35, such as a 3×3 array. As shown in FIG. 5, the ultrasonic transducer 25 can have a maximum outer transverse dimension D₁ of less than 5 mm. The array 35 can likewise have a maximum outer transverse dimension D₂ of less than 5 mm. For example, an outer diameter between two corners, such as opposed corners of the array 35, can have a maximum outer dimension of less than 5 mm. For instance, as illustrated in FIG. 5, each corner of the array can be disposed on a circle having a diameter D₂ of less than 5 mm. In another example, the array 35 has an outer dimension D₂ (e.g., diameter) of 3 mm or less. The small dimension of the array 35 allows the placement of the probe 15 in a small area, such as within an external auditory canal of an ear and facing an interface of the ear such as the tympanic membrane. Additionally, when used in an area such as the external auditory canal, forward facing geometry of the transducers can provide a desirable operating position. For instance, the areas of interest in the canal can include the tympanic membrane and/or locations behind the tympanic membrane, which are oriented generally perpendicular with respect to the external auditory canal.

In accordance with one aspect of the present invention, each transducer element 30 within the array 35 is oriented along a different direction. Thus, the ultrasonic pulses are transmitted and received at different directions. This configuration compensates for geometry variations. For instance, when used in an ear, transmitting and receiving the ultrasonic pulses at different directions compensates for variation in the shape of the tympanic membrane and external auditory canal. The orientation of the array 35 can be realized by placing the transducer elements 30 in a three-dimensional curved array on the probe 15. For instance, the transducer elements 30 can be placed on a spherical convex end surface portion of the probe 15. It is to be appreciated that the transducer elements 30 may be arranged in some other non-planar fashion, with some means (e.g., varied orientation) to provide the differing direction. However, the spherically curved array 35 arrangement provides a readily obtainable effect of each transducer being aimed at a different beam angle. Each transducer element is oriented such that the associated signal is output along a direction that is different from directions associated with the other transducer elements. For instance, the transducer element center-to-center distance can be between 200 and 500 μm, the distance between each adjacent transducer element on the face can be less than 50 μm, for example about 25 μm, and the transducer face can have a spherical radius of curvature of less than 5 mm, for example about 3 mm. This configuration offers a beneficial tradeoff between the two-way sensitivity of a single element and spatial resolution of each element in the convex spherical configuration. As a corollary, the receipt of the reflected signal back to each transducer is generally along the same direction. The output and receipt of a signal along a direction can be thought of as “aiming” the signal along a beam angle.

It is to be appreciated that all constructions and/or methodologies for directing the signals are intended to be within the scope of the present invention. For example, the probe 15 may have just a single transducer element and a means, such as a device or some other directing arrangement, to direct or target each subsequently transmitted signal toward a different ear portion. Such an arrangement could be considered to be a mechanical scanner. The targeting could sweep signals over an area of the ear.

When used within an ear, due to the complex geometry of the ear, only ultrasonic signals (e.g., beams) originating from certain beam angles will produce useful data. Therefore, the orientation along different directions (e.g., curved array) of transducer elements 30 ensures that an ideal beam angle will be present and will generate useful data. Also, it is contemplated that a useful signal may be transmitted from a first transducer element and received by a second transducer element. Thus, more than one transducer element can be utilized to produce useful data.

Further, in accordance with an aspect of the present invention, a “burst” of a plurality of transducer elements may be used to appropriately position the probe. For instance, five elements arranged in a cross pattern, or any other suitable pattern, can be operated or “fired” at the same time within an ear. The signal received from the “burst” of transducer elements can indicate a distance between the transducer elements and the tympanic membrane of the ear, thereby facilitating positioning of the probe within the ear canal. Once the probe has been properly positioned, the transducer elements 30 may be fired sequentially, rather than simultaneously. For example, the transducer elements may be fired individually in a sequential manner, or may be fired in sets in a sequential manner. By firing the transducer elements sequentially, it can be determined which transducer element or set of transducer elements are positioned at the most useful beam angle. The transducer element positioned at the most useful beam angle can provide the highest signal to noise ratio. Thus, examples of the present invention use data from one selected transducer element determined to be at the most useful angle in order to obtain the most accurate determination concerning ear disorder detection. In further examples data from two or more transducer elements may also be used that provide similar useful information.

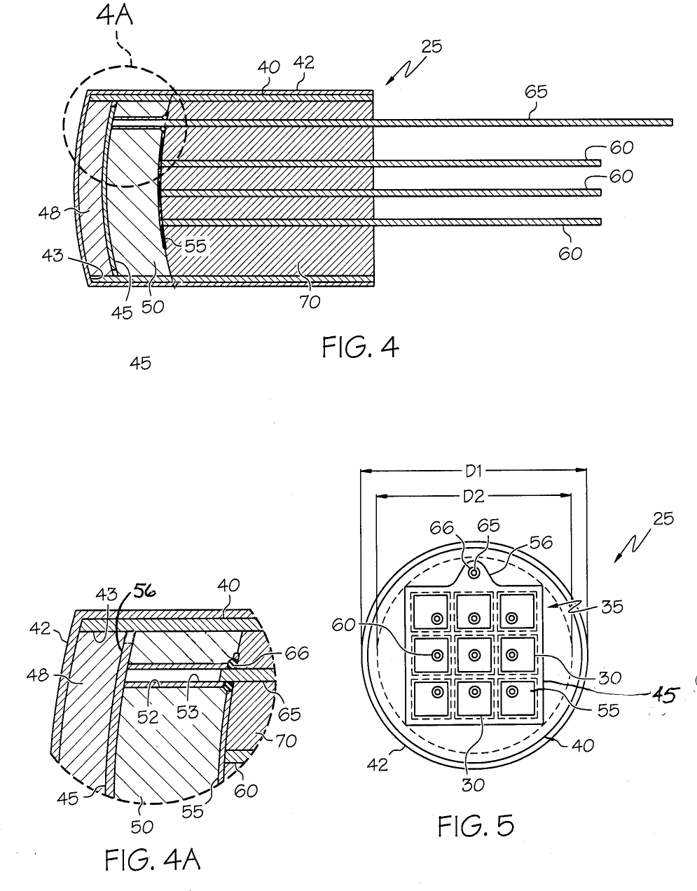

FIGS. 2-5 illustrate an example of an ultrasonic transducer device that can comprise portions and/or the entire ultrasonic transducer 25 in accordance with aspects of the present invention. FIG. 4 depicts a cross sectional side view of the ultrasonic transducer 25. As shown, the ultrasonic transducer 25 can include a transducer material layer 50 with a convex surface and a concave surface. In one example, as shown in FIG. 4A, the transducer material layer 50 can include a bore 52 lined with a conductive layer of material 53. In one example the conductive layer can comprise copper, although other suitable conductive materials may be used in further examples. The transducer material layer 50 can comprise various types of materials. For example, the transducer material layer 50 can comprise a workable piezoelectric material, such as a composite that comprises piezoelectric ceramic suspended in epoxy, to allow the material to be bent into the correct shape as discussed below. In further examples, the transducer material layer may be formed from a mosaic of relatively brittle ceramic tiles. However, the workable piezoelectric material can allow a substantially continuous layer of material to be easily formed into the correct shape.

The ultrasonic transducer 25 can further include a contact plating layer 55 including a convex portion disposed on the concave surface of the transducer material layer 50. The convex portion of the contact plating layer 55 can also include a plurality of transducer elements 30 arranged in an array 35. The transducer array 35 can include nine transducer elements 30 arranged in a 3×3 array in accordance with an aspect of the present invention. It is to be appreciated that the transducer array can include any number of transducer elements arranged in any suitable configuration and is contemplated as falling within the scope of the present invention. The contact plating layer 55 can comprise conductive material, such as copper or any other suitable material. The contact plating layer 55 can include a conductive bias to provide for electrical connections on one side of the contact plating layer 55.

In accordance with further aspects, the ultrasonic transducer 25 can further include an acoustic matching layer 48 including a convex surface facing away from the transducer material layer 50 and a concave surface facing towards the transducer material layer 50. The acoustic matching layer 48 can comprise polyvinylidene fluoride, or any other suitable material. The ultrasonic transducer 25 can further include a top plating layer 45 at least partially disposed between the convex surface of the transducer material layer 50 and the concave surface of the acoustic matching layer 48. As shown, the top plating layer 45 can also be arranged in electrical communication with the conductive layer 53. As shown, the ultrasonic transducer 25 can further include an electrical ground member 65, such as the illustrated ground wire, positioned in electrical communication with the top plating layer 45, for example, by way of the conductive layer 53. At the same time, the electrical ground member 65 can be electrically isolated from the contact plating layer 55. In one example, a gap can exist between the ground member 65 and the contact plating layer 55 to provide electrical isolation. In another example, an epoxy or other nonconductive material may be positioned within the gap. In a further example, as illustrated, an optional isolation ring 66 may be placed in the gap although other arrangements may be provided to provide electrical isolation between the contact plating layer 55 and the ground member 65. In further examples, the electrical ground member 65 may be extended through the bore 52 to directly contact the top plating layer 45. The top plating layer 45 can comprise copper, or any other suitable material.

As further illustrated, the ultrasonic transducer 25 can include at least one electrical contact member in electrical communication with at least one of the transducer elements 30. For example, at least one of the transducer elements 30 can be provided with an electrical contact member, such as the illustrated electrical contact wire 60, extending from the contact plating layer 55. As shown in the figures, a contact wire 60 or other electrical contact member can abut each corresponding transducer element 30 and/or extend from the contact plating layer 55.

The ultrasonic transducer 25 can also include an outer shell 40 including an interior area and an open end 43 in communication with the interior area. As shown, the transducer material layer 50, the contact plating layer 55, the acoustic matching layer 48 and the top plating layer 45 are at least partially disposed within the interior area of the outer shell 40. Moreover, as shown in FIGS. 4 and 4A, a portion of the acoustic matching layer 48 can extend through the open end 43 such that at least a portion of the convex surface of the acoustic matching layer 48 is disposed outside of the interior area of the outer shell 40. The shell 40 can comprise a stainless steel tube. However it is to be appreciated that any suitable material can be used for the outer shell 40 of the ultrasonic transducer 25.

As further shown in FIGS. 4 and 4A, the ultrasonic transducer can further include a backing material layer 70 disposed within the interior area of the outer shell 40. The contact wires 60 and the ground wire 65 can be suspended with respect to the contact plating layer 55 by the backing material 70. The backing material layer 70 can comprise tungsten epoxy or other suitable material.

The ultrasonic transducer 25 can further include a thin insulating layer 42, such as a thin polymer coating, that at least partially encapsulates an outer surface of the ultrasonic transducer to provide dielectric insulation. For example, as shown in FIG. 4, a thin insulating layer can comprise a polymer coating, such as a parylene coating, having an example thickness of 5 μm can be applied over an outer surface of the transducer 25, thereby substantially encapsulating portions of the ultrasonic transducer 25 to provide appropriate dielectric insulation.

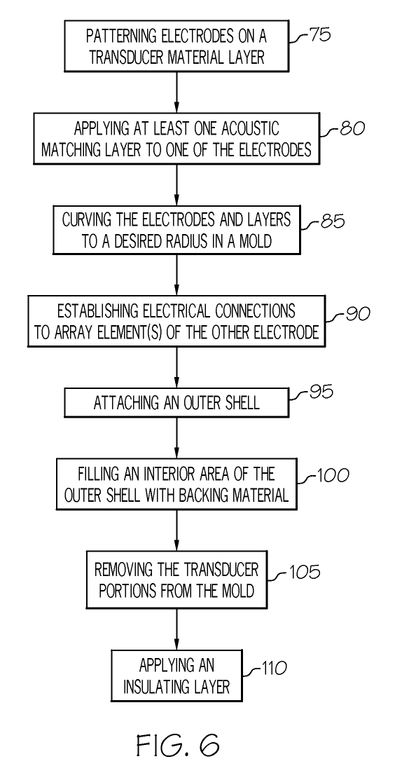

FIG. 6 illustrates just one example methodology for producing the ultrasonic transducer with the understanding that other methodologies may be used to produce ultrasonic transducers incorporating aspects of the present invention. Furthermore, the steps illustrated and described with respect to FIG. 6 may be performed in different orders and/or the methodology may include more or less steps than illustrated and described with respect to the illustration. As shown in FIG. 6, an example methodology of manufacturing the ultrasonic transducer 25 can be considered to begin at step 75 where metal electrodes are patterned on the transducer material layer 50. More particularly, the contact plating layer 55 can be disposed on one side of the transducer material layer 50 and the top plating layer 45 can be disposed on the opposite side of the transducer material layer 50. In example embodiments, step 75 can further include lining the bore 52 with a conductive layer 53 that is in electrical communication with the top plating layer 45. In further examples, an insulation ring 66 can be installed to provide electrical insulation between the contact plating layer 55 and the conductive layer 53. Once installed, as shown in FIG. 5, the insulation ring 66 can be positioned through an aperture in an extension 56 of the contact plating layer 55.

As further shown in FIG. 6, step 80 can include applying at least one acoustic matching layer to one of the electrodes. For example, the acoustic matching layer 48 can be applied to the top plating layer 45. Step 85 can involve curving the metal electrodes (e.g., the contact plating layer 55 and the top plating layer 45), the transducer material layer 50 and the acoustic matching layer 48 to a desired radius in a mold. Curving of the contact plating layer 55 is possible because the ceramic material is sufficiently thin and/or can comprise a composite structure (e.g. polymer binding matrix) that provides flexibility. The curving can be accomplished by gently heating the electrodes and layers of material (e.g. to about 100-degrees Celsius) and pressing the material layers and electrodes into a spherically shaped mold using a matching ball bearing. At step 90, after the ball bearing is removed, but while the material layers and electrodes are still in the mold, electrical connections can be established with each ultrasonic transducer element 30 using wire bonding with the contact wires 60. Alternatively, electrical connections can be made via: the direct termination of coaxial wire (AWG 42-50 for example) by low temperature solder, conductive epoxy, or the like; epoxy bonding of flex circuit with an appropriate pattern that corresponds to the metal electrode pattern on the contact plating layer 55; or z-axis backing. At step 95, the outer shell 40 can then be attached. In the illustrated example, the outer shell 40 can comprise a housing with a substantially tube-shape and can have an outer diameter of about 5 mm or less. As shown in FIG. 4, the outer shell 40 is attached such that a face of the acoustic matching layer 48 protrudes slightly from the open end 43 of the outer shell 40. At step 100, an interior area of the outer shell 40 can be filled with the backing material 70. In one example, the backing material 70 can comprise tungsten epoxy that is injected through a rear opening of the outer shell 40. At step 105, the assembled portions of the ultrasonic transducer 25 can then be removed from the mold at 105. The insulating layer 42 can then be applied to an outer surface of portions of the ultrasonic transducer 25. For example, a thin coating of parylene, for example about 5 μm, can then be applied over an outer surface to assure dielectric insulation. The ultrasonic transducer 25 can then be coupled to a controller, such as an electronic data collection device, via a cable or the like.

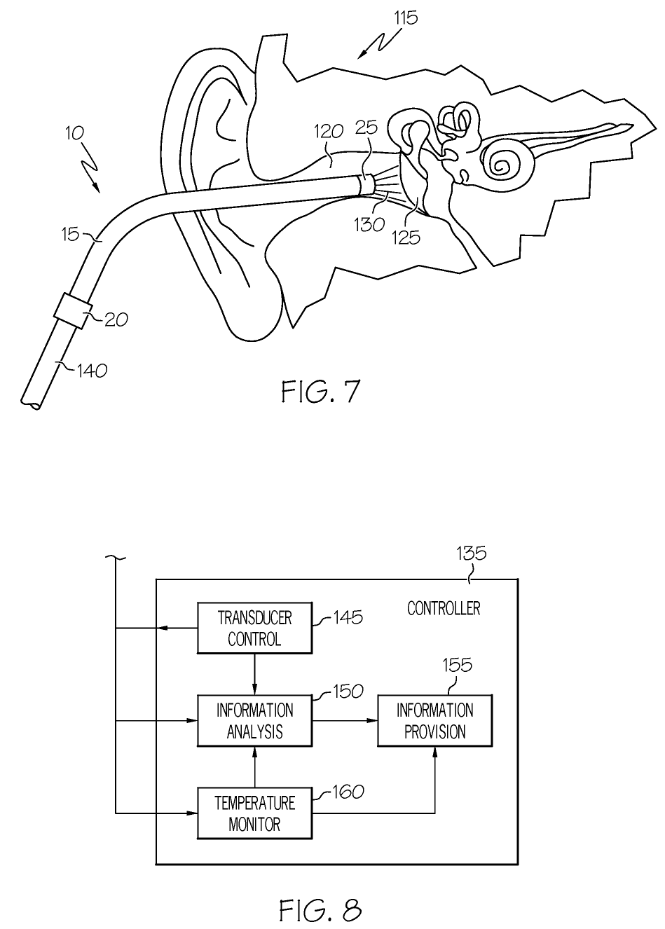

FIG. 7 illustrates the detection apparatus 10 used in an ear environment 115 in accordance with an aspect of the present invention. The probe 15 interacts with the ear environment 115 and may be inserted into (e.g., penetrate into the space of) an ear canal 120 of the ear environment 115. A conformable sleeve may be provided to encapsulate all or a substantial portion of the probe 15. The sleeve provides conformability and comfort, and helps enable the probe 15 to be useable with a variety of ear sizes. The sleeve may be made of any material suitable to allow such conformability and comfort, such as silicone or polyurethane elastomers. It is to be appreciated that the probe 15 may have a variety of shapes, configurations, etc. For example, the probe may be configured as an earmuff or headphone arrangement.

The probe 15 is inserted into the ear canal 120 such that the face of the probe 15 faces at least a portion of the tympanic membrane 125. Because the face of the probe 15 is generally convex, the ultrasonic pulses from the transducers are transmitted and received in different directions, as shown by the illustrated beam rays 130. Accordingly, the probe 15 is able to transmit and receive ultrasonic pulses over a larger area of the tympanic membrane 125 than a probe having a substantially flat face configuration. During an examination for MEE with an ultrasonic device, after emission from a transducer on the detection apparatus, the ultrasound wave must be substantially perpendicular with respect to the anatomical structures of the ear (e.g., tympanic membrane, middle ear wall) in order for the reflection of the ultrasound wave to be received by the transducer sensing element. Because of the complex geometry of the external auditory canal, manubrium of the malleus obscuring part of the middle ear cavity, the angle between the tympanic membrane and the external auditory canal, for example, it is desired to have the capability of emitting and receiving the ultrasound at different angles from the ultrasonic transducer.

The detection apparatus 10 is coupled to a controller 135 via a cable 140. The controller 135 includes structure (e.g., components) for operation control, information analysis, information provision to a user (e.g., a medical examiner) of the apparatus, and possibly other functions. The structure associated with the control, analysis, provision, etc. is schematically shown in FIG. 8. Herein, the schematically shown structure is referred to as a controller 135, with an understanding that the controller can perform multiple functions. It is to be understood that the controller 135 can have a variety of designs, configurations, etc. Further, it is to be understood that specifics concerning the controller 135 are not intended to be limitations on the present invention. Any structure and/or configuration capable of performing the functions described herein may be utilized. Such variation of the structure is intended to be within the scope of the present invention.

The controller 135 includes a transducer control 145 for controlling operation of the transducers. In one example, the firing of each transducer is accomplished via the transducer control portion 145 providing the electrical stimulus signal to each respective transducer element 30. The controller 135 also receives the return electrical signals upon receipt of the return ultrasonic signals by the transducer elements 30. In one example, operation by the transducer control portion 145 is controlled such that the transducer elements 30 are sequentially fired. Of course, the control provided by the transducer control portion 145 would be appropriate to the number, type, etc. of transducer element(s), and would control other aspects such as a targeting arrangement as needed.

The controller 135 further includes an information analysis portion 150 for analyzing the information conveyed within the reflected signal (e.g., one or more characteristics of the reflected signal) and transmitted to the controller via the electrical return signal. As one example, the information analysis portion 150 can analyze the reflected signal amplitude and/or frequency spectrum. As a specific example, the viscosity of fluid contained in the ear can be determined, such as by analysis of the reflected signal amplitude and/or frequency spectrum characteristics. However, it is to be understood that other determinations concerning ear disorders can be made. Also, it is possible that ear disorders that are not related to fluid viscosity can be discerned. Further, aspects other than viscosity can be discerned concerning the fluid within the ear.

Of course, the analysis provided by the information analysis portion 150 would be appropriate to the number, type, etc. of transducer(s), and can factor in other aspects such as targeting, as needed. For example, the information analysis portion 150 may provide analysis of signals transmitted from a first transducer element and received at a second transducer element.

Also, the controller 135 can include an information provision portion 155 for providing analysis information to the user of the apparatus 10. The information provision portion 155 may include a display from which the user may discern the information.

The information analysis portion 150 uses the signal information to determine if an ear disorder exists. In one example, only the signal from one transducer element is used to determine an accurate indication for the ear disorder detection. For example, the utilized signal can be based upon selection of a transducer element that provides the best signal to noise ratio. The best indication is logically the transducer element that is directed toward a certain portion of the ear for reflection therefrom. In one example, the certain portion is the tympanic membrane. As such, the information analysis portion 150 can determine which transducer element is directed at the certain ear portion (i.e., the tympanic membrane) via signal analysis.

The signal analysis can be made easy via control the transducer elements to operate sequentially. The use of a sequential operation approach allows analysis without conflict from other signals. The transducer control portion 145 and the information analysis portion 150 of the controller 135 can thus interact and cooperate to accomplish this feature. However, it is to be appreciated that certain aspects of the present invention may not be limited to single transducer signal use for disorder determination and/or sequential operation.

One specific example of the apparatus 10 may include a temperature sensing means (not shown) that is operatively connected to a temperature monitoring portion 160 of the controller 135. The temperature sensing means may be attached to or integrated with the probe 15 so that temperature measurements of the ear environment 115 may be taken in connection with operation of the transducer array 35. The temperature sensing means may be, for example, a thermometer or other suitable device known in the art. The temperature monitoring portion 160 can be operatively connected to the information provision portion 155 such that the temperature information is also provided to the user.

Another specific example of the apparatus 10 may include a fluid delivery system (not shown) for delivering and removing ultrasound transmitting medium to and/or from the canal 120 of the ear environment 115. The ultrasound transmitting medium may, inter alia, assure an acoustic coupling between the ear environment 115 and the transducer elements and may comprise, for example, water, saline, and/or other commercially available known fluids, such as AYR-SALINE, NASAL-GEL or VO-SOL, etc. The fluid delivery system may be included within the probe 15. In one example, the fluid delivery system can comprise an ultrasound transmitting medium outlet and, optionally, an ultrasound transmitting medium inlet. The outlet can provide a means by which the ultrasound transmitting medium may be delivered to the ear environment 115, such as into the ear canal 120. The optional inlet can provide a means of evacuating the ultrasound transmitting medium after conducting a detecting operation. The outlet and inlet may be connected, for example, by flexible tubing to external devices, such as a reservoir for containing the ultrasound transmitting medium. The use of flexible tubing may be advantageous in examinations involving pediatric patients because such flexible tubing permits the patient to retain movement of the head during data acquisition.

It is to be appreciated that the apparatus 10 may have any suitable configuration, set-up, etc. As shown herein, the components of the controller 135, (e.g., the transducer control portion 145, the information analysis portion 150, the information provision portion 155) are schematically depicted as being separate from the probe. However, it is to be understood that the apparatus 10 may be embodied in other suitable forms, such as a self-contained hand-held unit that directly incorporates such components as the transducer control portion 145, the information analysis portion 150, the information provision portion 155 and/or the temperature monitoring portion 160. In addition or alternatively, the apparatus 10 may include additional components.

As another aspect of the present invention, one or more ear disorders are detected by a method. In one example, the method includes the steps of providing a probe 15 that includes a plurality of transducer elements 30, interacting the probe 15 with an ear, operating the plurality of transducer elements 30 to provide information, and determining the existence of an ear disorder using the information. In another example, the method includes providing the probe 15, which includes the plurality of transducer elements 30 arranged in a curved array 35. The probe 15 is interacted with the ear, and the existence of an ear disorder is determined. The method may further include any of the following steps: inserting the probe 15 into the ear canal 120, introducing an ultrasound transmitting medium into the ear canal 120, sequentially firing the transducer elements 30, receiving reflected signals, and evacuating the ultrasound transmitting medium from the ear canal 120. In further examples a method step of measuring the temperature of the ear can be performed. Further, it is contemplated that this method can be performed within a relatively short time period (e.g., 60 seconds or less).

It is to be appreciated that the present invention can provide for MEE detection by analysis of reflected ultrasonic signals generated from miniature transducer elements that may be arranged in a curved array. The MEE detection may be non-invasive and may be performed on a conscious patient without the need for anesthesia. The ultrasonic detection of MEE is based on the analysis of the ultrasonic signal reflected (e.g., an echo) from the tympanic membrane and, in the case of effusion, a second echo reflected from the middle ear cavity. In the case of a normal ear, a significant portion of the ultrasonic signal energy is reflected due to the mismatch between acoustic impedance of the tympanic membrane and the impedance of air filling the middle ear cavity. When the effusion is present, the energy of a reflected pulse from the tympanic membrane is significantly lower. This is due to the good match of impedances of the tympanic membrane and the fluid, which allows the pulse to penetrate into the middle ear cavity, thereby creating a second echo reflecting back from an interior wall or other structure of the middle ear cavity.

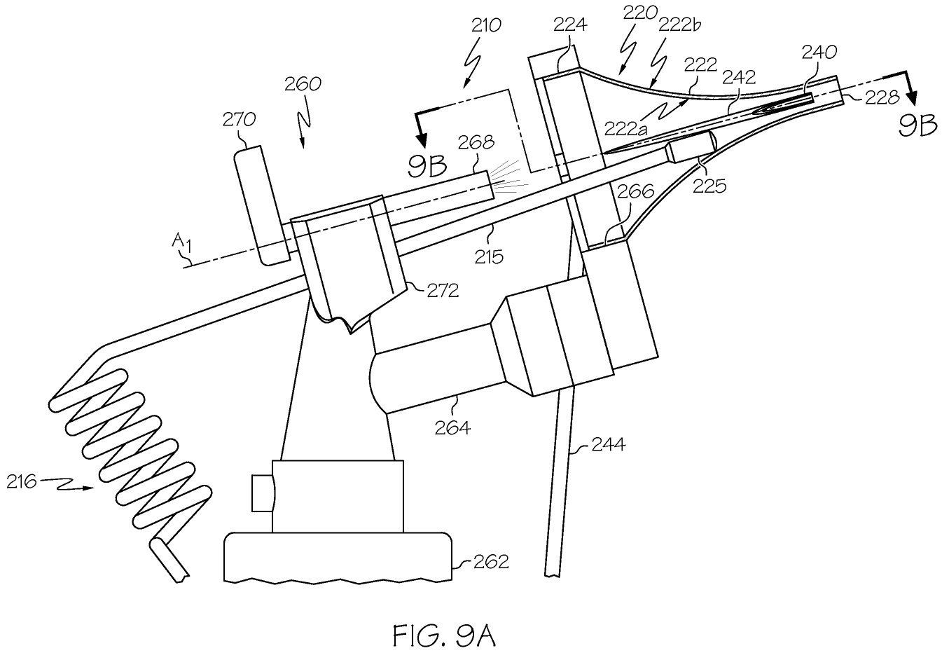

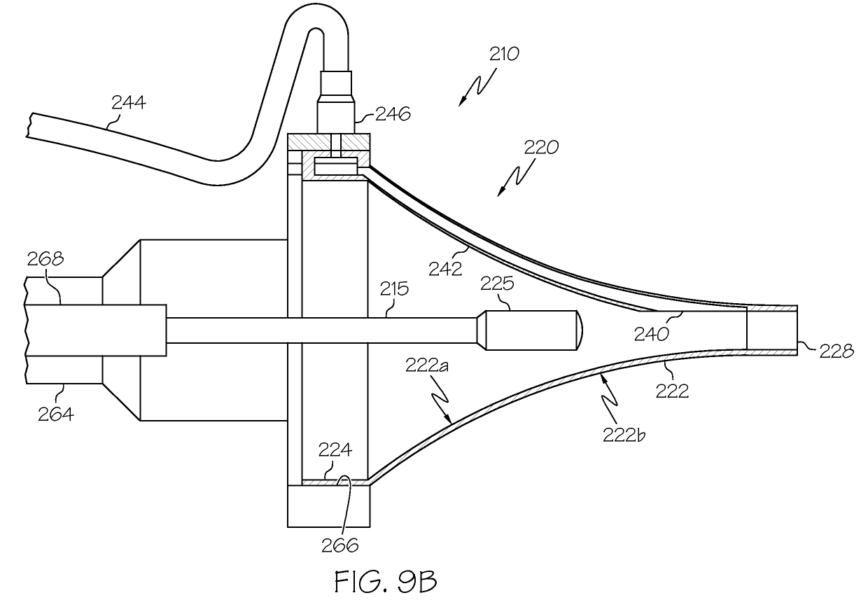

Various alternative detection apparatus may be provided in accordance with the present invention. For instance, as discussed above, the detection apparatus 10 may be provided as illustrated in FIG. 7. In further examples, detection apparatus may comprise a positioning device including a wall with a substantially conical inner surface. For example, FIGS. 9A and 9B illustrate one example of a detection apparatus 210 including a positioning device 220 including a wall 222 with a substantially conical inner surface 222a. The substantially conical inner surface can include a frustoconical shape. In one example, the frustoconical shape has a contour that follows a cone having a straight profile extending from the base to the truncated tip. In still further examples, as shown in FIGS. 9A and 9B, the substantially conical inner surface 222a can include a frustoconical shape with a contour that follows a cone having a curved profile from the base to the truncated tip. As discussed above, and in further examples, the substantially conical inner surface can be considered to extend along a surface generated by a straight or curved line at least partially rotated about an axis A₁ of the detection apparatus 210. In the illustrated example, the wall 222 can substantially encircle the axis A₁ wherein the straight or curved line is substantially entirely rotated about the axis. Although not shown, it is contemplated that the wall may not entirely encircle the axis A₁. For instance, the wall may partially extend about the axis A₁ wherein the straight or curved line is only partially rotated about the axis A₁.

The detection apparatus 210 can further comprise a detection device 225 configured to send and receive signals. In one example, the detection device 225 can comprise an ultrasonic transducer, similar or identical to the ultrasonic transducer 25 described above, although other types of detection devices may be incorporated in further examples. The detection device 225 can be incorporated at an end of a probe 215. The probe 215 can be provided with a flexible coil 216 to facilitate movement of the probe 215 with respect to the positioning device 220. Moreover, a portion of the probe 215 can pass through a guide structure 272 of the detection apparatus 210. For example, the guide structure can comprise a slot or aperture configured to receive a portion of the probe 215 to guide the probe as the detection device 225 travels between the retracted position and the detection position.

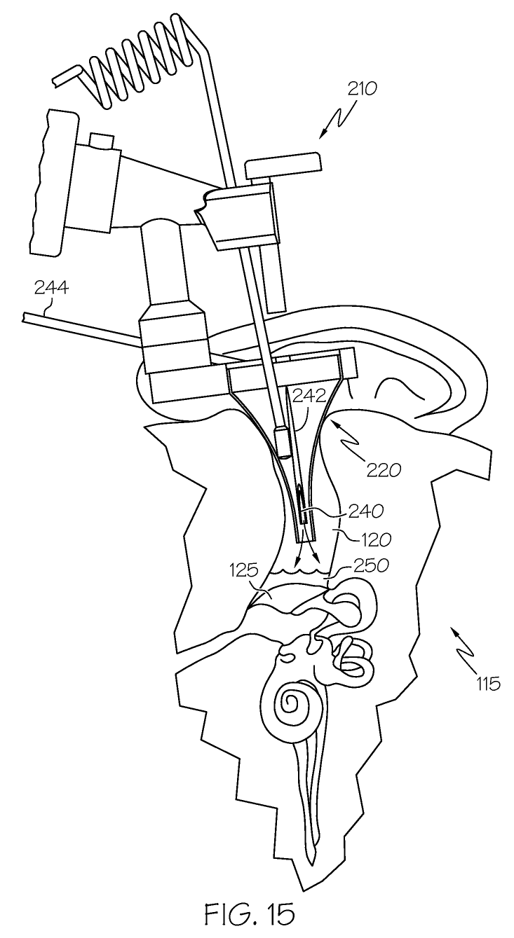

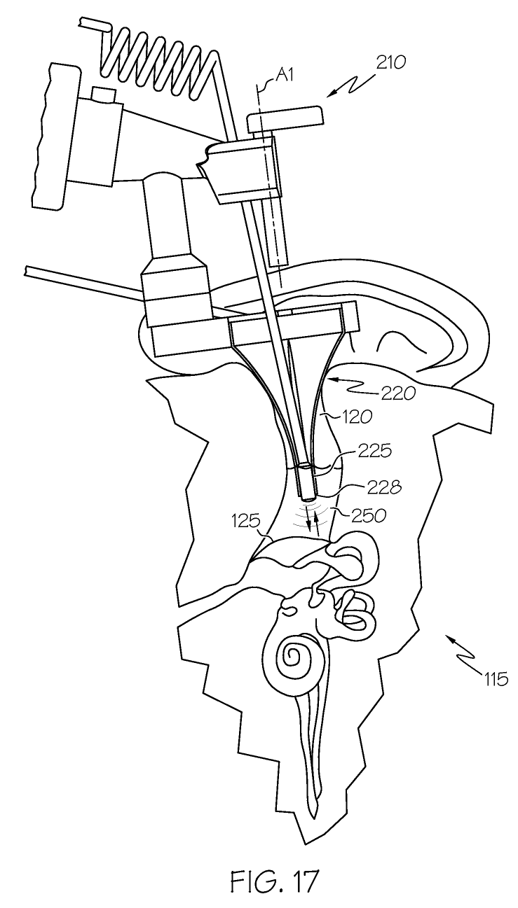

Providing the wall 222 of the positioning device 220 with a substantially conical inner surface 222a can provide a positioning surface for the detection device 225. Indeed, the substantially conical inner surface 222a can act as a guide to radially move the detection device 225 toward the axis A₁ from a retracted position (see FIG. 9A and 15) to a detection position (see FIG. 17). More particularly, as shown in FIG. 9A the device 225 is substantially offset with respect to the axis A₁ of the wall 222 in the retracted position. In contrast, as shown in FIG. 17, the detection device 225 is substantially aligned with respect to the axis A₁ of the wall 222 in the detection position A₁.

In further examples, the wall 222 of the detection apparatus 210 can include a substantially conical outer surface 222b. As shown, in another example, the substantially conical outer surface 222b can have a shape that is mathematically similar to the substantially conical inner surface 222a such that the wall 222 has a substantially uniform thickness. Although not shown, it is contemplated that the wall 222 may have a nonuniform thickness. For instance, the wall 222 may taper along a portion of the axis A₁. Providing the wall 222 with a substantially conical outer surface 222b can provide a positioning surface for the apparatus 210. For example, the substantially conical outer surface 222b may act as a guide against surfaces of the ear canal to position an opening 228 of the positioning device 220 at an appropriate position with respect to an ear canal 120 as described more fully below.

In further examples, the detection apparatus 210 can include a fluid outlet port for delivering fluid into the ear canal, thereby assisting in transmitting signals from the detection device 225 to the surface of the ear (e.g., the tympanic membrane) being tested. The fluid outlet port can be provided at various locations of the detection apparatus 210. In one example, the fluid outlet port is incorporated as part of the detection device 225. In such examples, the fluid may be delivered to the test site when the detection device 225 is located in the detection position. It is also contemplated that fluid may alternatively be delivered in the retracted position wherein fluid is funneled by the substantially conical inner surface 222a to the appropriate location. Alternatively, as shown, the positioning device 220 may include one or more fluid outlet ports 240 configured to deliver fluid through the opening 228 of the positioning device 220. As further shown in FIG. 9B, the positioning device 220 can include a conduit 242 incorporated into the wall 222 of the positioning device 220 to deliver fluid from a fluid supply device 244 provided in fluid communication with the conduit 242 by way of a fluid coupling 246. The fluid supply device 244 can comprise a flexible tube that is in communication with a source of fluid (not shown).

As further shown in FIG. 9A, the detection apparatus 210 can include an observation device 260 to facilitate observation of the test site prior to conducting a detection operation. As shown, the observation device can include a light device 268 configured to emit light along the axis A₁ to pass through the opening 228 of the positioning device 220. Aligning the light device 268 along the axis A₁ can help illuminate the detection area, such as the tympanic membrane when the detection device 225 is oriented in the retracted position.

The observation device 260 can further include an optional viewing lens 270 to view the test area prior to conducting the test procedure. In one example, the viewing lens 270 can provide magnification of the test area. Furthermore, if provided with a light device 268, the view lens 270 can receive light being reflected back from the test area to help provide a full color visual inspection of the test area.

The detection apparatus 210 can further include structures to provide support for features of the apparatus and handling of the apparatus. For example, the detection apparatus 210 can include a handle 262 to permit manual manipulation of the apparatus 210. In further examples, the handle 262 may not be provided or the handle may be clamped to a support structure configured to appropriately orient the apparatus 210. As further illustrated the test apparatus 210 can include a support arm 264 configured to support the positioning device 220. The support arm 264 can be integrally attached to the positioning device 220. Alternatively, the positioning device 220 can be removably attached to the support arm 264 in further examples. Providing removable attachment can be desirable to allow removal and replacement of the positioning device. For instance, the positioning device may be a disposable-type positioning device designed for a single use. In such examples, the used positioning device may be removed from the support arm for disposal. The used positioning device can be replaced with a new sterile positioning device for subsequent uses of the detection apparatus with different patients.

The positioning device 220 can be removably attached to the support arm 264 in a wide variety of ways. As shown in the illustrative example, the support arm 264 can be provided with a female opening 266 configured to receive a male support portion 224 of the positioning device 220. Attachment of the positioning device 220 can be achieved by an interference fit between the male support portion 224 and the female opening 266. It is also contemplated that the opening in the base 224 can act as a female opening to receive a male insert of the support arm in further examples. It is further contemplated that other attachment arrangements (e.g., mechanical attachment arrangements such as ring clamps or the like) may be used in further examples to conveniently removably attach the positioning device 220 to the support arm 264.

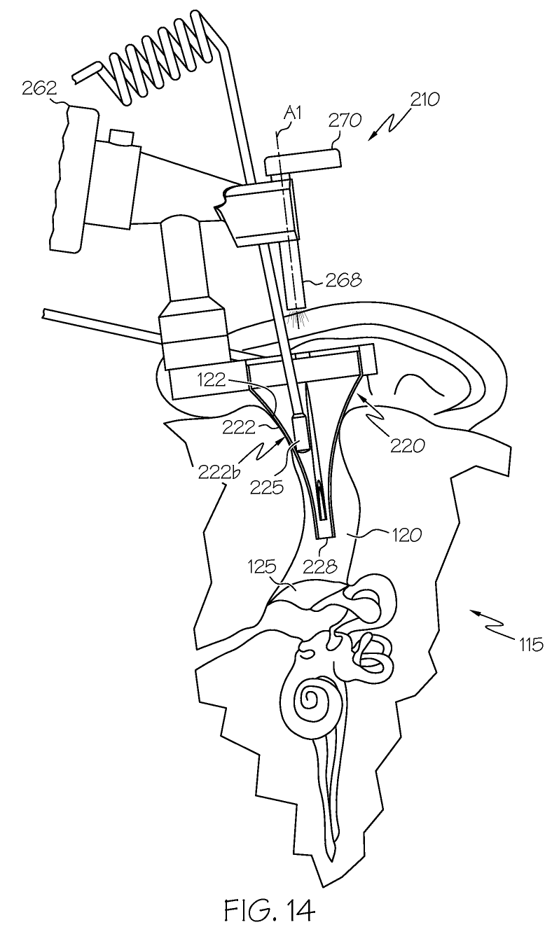

A method of using the detection apparatus 210 illustrated in FIGS. 9A and 9B will now be described with reference to FIGS. 14-16. As shown in FIG. 14, the positioning device 220 may be oriented with respect to the ear canal 120 of the ear environment 115. In one example, an operator may manually manipulate the detection apparatus 210 by way of the handle 262 to insert the opening 228 of the positioning device 220 into the ear canal 120. The positioning device 220 is then inserted until the substantially conical outer surface 222b engages an opening area 122 of the canal 120 to appropriately position the opening 228 at a location spaced from the tympanic membrane 125.

The detection apparatus 210 can also be used to visually inspect an area of the ear. For example, with further reference to FIG. 14, the light device 268 can direct light along the axis A₁ to illuminate the tympanic membrane 125 and surrounding areas of the ear environment 115. The view lens 270 can then be used to visually inspect the tympanic membrane 125 and surrounding areas of the ear environment 115 when the detection device 225 is oriented in the retracted position. Indeed, in the retracted position, the detection device 225 is substantially offset with respect to the axis A₁ of the wall 222 to allow passage of light and viewing through the opening 228 of the positioning device 220.

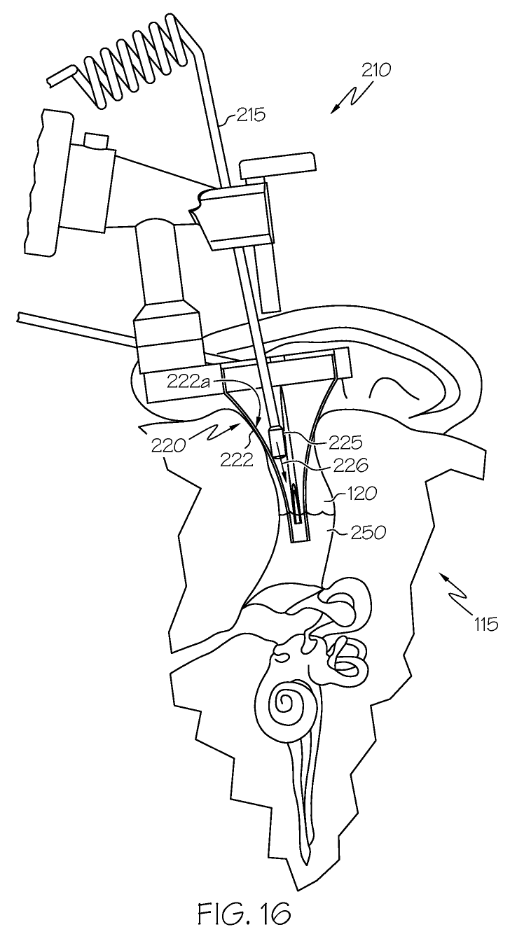

The detection apparatus 210 can also be used to move the detection device 225 along the substantially conical inner surface 222a of the wall 222 from the retracted position shown in FIGS. 14-16 to the detection position shown in FIG. 17. Indeed, as shown in FIG. 16, the probe 215 may be moved such that the detection device 225 moves along direction 226. As the detection device 225 moves along the direction 226, the interaction between the detection device 225 and the substantially conical inner surface 222a can radially move the detection device 225 from a position offset from the axis A₁ (see FIGS. 14-16) to a position aligned with the axis A₁ as shown in FIG. 17.

As shown in FIG. 17, in the detection position, an end of the detection device 225 can extend through the opening 228 of the positioning device 220. The detection apparatus 210 can then be used to detect a condition of the ear. For example, as shown in FIG. 17, the detection device 225 can send signals. The sent signals are then reflected off of the tympanic membrane 125 and/or other areas of the ear and thereafter received by the detection device 225. The received signals can then be analyzed, for example, as described more fully above.

In a further example, the method of using the detection apparatus 210 can further include the step of introducing fluid 250 into the ear canal 120 to facilitate transmission of the signals between the detection device 225 and the tympanic membrane 125. The fluid 250 can comprise, for example, water, saline, and/or other commercially available known fluids, such as AYR-SALINE, NASAL-GEL or VO-SOL, etc. For example, as shown in FIG. 15, the head of the patient may be oriented such that the ear canal 120 is open vertically upward such that dispensed fluid 250 does not drain out of the ear canal 120. Next, the fluid supply device 244 is used to supply fluid to the positioning device 220. The fluid then passes through the conduit 242 and exits the fluid outlet port 240 to begin at least partially filling the ear canal 120 with fluid 250 as shown in FIG. 15. Fluid 250 is supplied until an appropriate level of fluid is received in the ear canal 120 as shown in FIGS. 16 and 17. The detection procedures can then be carried out as discussed above.

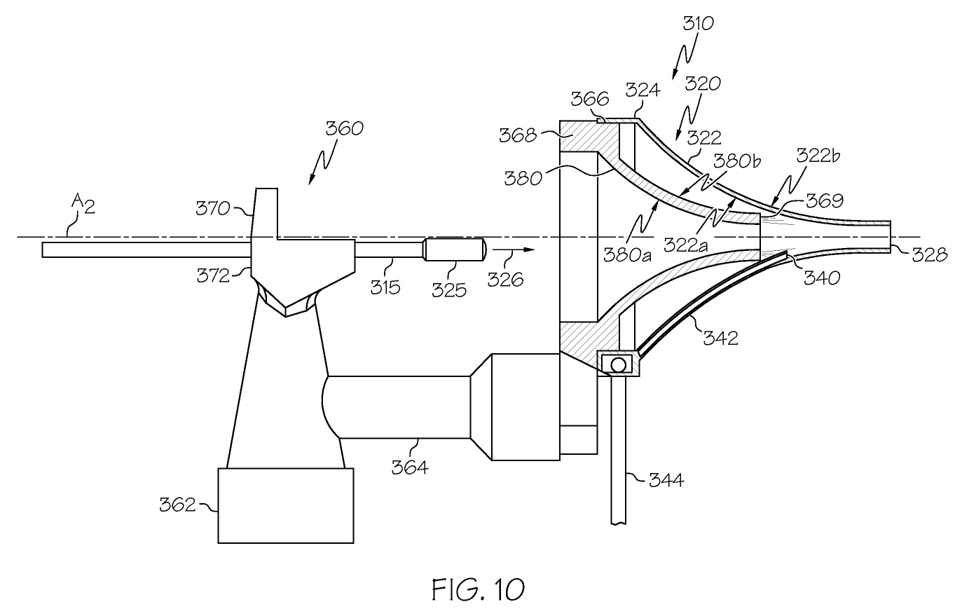

Various other detection apparatus may incorporate one or more aspects of the invention. For example, FIG. 10 illustrates another example of a detection apparatus 310 that, unless otherwise mentioned, can include many of the characteristics and may be used in many of the same ways as the detection apparatus 210 described above. As shown, the detection apparatus 310 includes a detection device 325 configured to send and receive signals. In one example, the detection device 325 can comprise an ultrasonic transducer, similar or identical to the ultrasonic transducer 25 described above. It will be appreciated that other types of detection devices may be incorporated in further examples. In one example, the detection device 325 can be incorporated at an end of a probe 315. The probe 315 can be provided with a flexible coil (not shown) to facilitate movement of the probe 315 with respect to a positioning device 320. Moreover, a portion of the probe 315 can pass through a guide structure 372 of the detection apparatus 310. For example, the guide structure can comprise a slot or aperture configured to receive a portion of the probe 315 to guide the probe as the detection device 325 travels between the retracted position and the detection position.

The detection apparatus 310 can further include a positioning device 320 with a wall comprising a first wall 322 with a substantially conical outer surface 322b and a second wall 380 including a substantially conical inner surface 380a. Providing the first wall 322 with a substantially conical outer surface 322b can provide a positioning surface for the detection device 325. For example, the substantially conical outer surface 322b may act as a guide against surfaces of the ear canal to position an opening 328 of the positioning device 320 at an appropriate position with respect to an ear canal. Moreover, the substantially conical inner surface 380a of the second wall 380 can provide a positioning surface for the detection device 325. Indeed, the substantially conical inner surface 380a can act as a guide to radially move the detection device 325 toward the axis A₂ from a retracted position to a detection position. As shown in FIG. 10, the device 325 is substantially offset with respect to the axis A₂ of the wall in the retracted position. However, in the detection position, the detection device 325 is substantially aligned with respect to the axis A₂ of the wall.

As shown, the first wall 322 can also include a substantially conical inner surface 322a that may be mathematically similar to the substantially conical outer surface 322b. The substantially conical inner surface 322a may act to further position the detection device 325 after the detection device exists the opening of the second wall 380. In addition, the second wall 380 can include a substantially conical outer surface 380b that may be mathematically similar to the substantially conical inner surface 380a. Providing similar inner and outer surfaces can provide each wall with a substantially uniform thickness. It will be appreciated that nonsimilar surfaces may be incorporated in further examples with nonuniform wall thicknesses.

As shown in FIG. 10, the first wall 322 and the second wall 380 are substantially concentric with respect to one another. In further examples, the walls may be oriented along different axes that are parallel or nonparallel with respect to one another.

The positioning device 320 may include one or more fluid outlet ports, such as the illustrated fluid outlet port 340, configured to deliver fluid through the opening 328 of the positioning device 320. As further shown in FIG. 10, the positioning device 320 can include a conduit 342 incorporated into the first wall 322 of the positioning device 320 to deliver fluid from a fluid supply device 344 provided in fluid communication with the conduit 342 by way of a fluid coupling. The fluid supply device 344 can comprise a flexible tube that is in communication with a source of fluid (not shown).

As further illustrated in FIG. 10, the detection apparatus 310 can further include a handle 362 with a support arm 364 and an observation device 360. As shown, the observation device 360 can include a light device 368 and a view lens 370 for viewing areas of the ear environment 115. As shown, the light device 368 can be incorporated into the second wall 380. Light generated by the light device 368 can be transmitted through optical fibers in the second wall 380 to form a light ring 369 to emit light for transmission through the opening 328 of the first wall 322.

At least a portion of the positioning device 320 can be removably attached to the support arm 364 in a wide variety of ways. As shown in the illustrative example, the support arm 364 can support the positioning device 320 by way of the second wall 380. Indeed, as shown, the opening in a support portion 324 of the positioning device 320 can act as a female opening to receive a male insert 366 of the second wall 380. As shown, the male insert 366 can be provided with a shoulder to limit the extent to which the support portion 324 can be inserted onto the second wall. An interference fit may exist between the positioning device 320 and the second wall 380 to provide appropriate removable attachment between the walls. It is also contemplated that the support portion of the positioning device may act as a male portion for inserting in a female opening of the second wall. It is further contemplated that other attachment arrangements (e.g., mechanical attachment arrangements such as ring clamps or the like) may be used in further examples to conveniently removably attach the positioning device 320 to the second wall 380.

The method of using the detection apparatus 310 can include steps that are similar and/or identical to the steps of using the detection apparatus 210 described above. It will be appreciated that movement of the probe 315 along direction 326 will eventually cause the detection device 325 to interact with the substantially conical inner surface 380a to cause the detection device 325 to axially move toward the axis A₂. After passing through the opening of the second wall 380, portions of the substantially conical inner surface 322a of the first wall 322 can further axially move the detection device 325 until the device is axially aligned with the axis A₂ and a portion of the detection device 325 extends outside of the opening 328 of the positioning device 320.

In further examples, the concepts of the detection apparatus 310 can be used to retrofit an existing otoscope to allow the otoscope to act as a detection device. Indeed, structures of an existing otoscope may be used to guide the probe 315. Alternatively, a guide structure may be added to an existing otoscope to provide appropriate support and guidance of the probe 315 as the detection device 325 moves from the retracted position to the detection position. Furthermore, the first wall 322 can be designed to be attached to an existing otoscope. For example, a wall or other portion of the existing otoscope can act as the male insert 366 wherein the female opening of the support portion 324 of the first wall 322 can be inserted over the existing male insert of the otoscope.

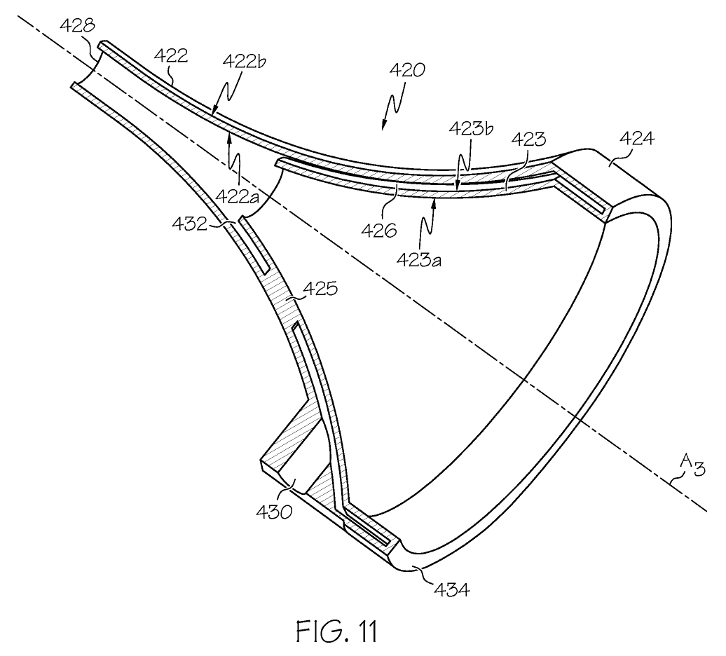

FIG. 11 illustrates another example of a positioning device 420. The illustrated positioning device 420 may be used as part of a wide variety of detection apparatus. For example, the positioning device 420 can be used as an alternative to the positioning device 320 of the detection apparatus 310 and/or as an alternative to the positioning device 220 of the detection apparatus 210. As shown, the positioning device 420 includes a first wall 422 and a second wall 423 spaced from the first wall. In one example, the first wall 422 can include a substantially conical inner surface 422a and a similar substantially conical outer surface 422b. Likewise, the second wall 423 can include a substantially conical inner surface 423a and a similar substantially conical outer surface 423b. Still further, the first and second walls 422, 423 can have a similar shape to define a circumferential fluid conduit 426 defined by the first and second walls 422, 423. In one example, the first and second walls 422, 423 are concentrically aligned with respect to one another to provide a substantially uniform circumferential fluid conduit 426. One or more spacers may be provided to help fix the position of the first and second walls 422, 423 with respect to one another. For example, as shown, a plurality of spacers 425 may be radially arranged around axis A₃ of the positioning device 420 to facilitate maintenance of the circumferential fluid conduit 426. The circumferential fluid conduit 426 can be closed at one end 434 and can have a circumferential outlet port 432 at the other end. An inlet port 430 can be provided for fluid communication with a fluid supply device. The positioning device can further include a support portion 424 that can be removably attached to other portions of the detection apparatus. In use, fluid supplied to the inlet port 430 is transferred to the circumferential conduit 426. The fluid can then exit the circumferential outlet port 432 to funnel down and exit through the opening 428 of the positioning device 420.

It will be appreciated that the positioning devices of the present invention may comprise a wide range of materials. For example, the positioning device may be formed from a thermoplastic material by an injection molding process. The positioning devices can be formed as separate elements that subsequently attached together. In further examples, the positioning devices can be integrally formed together. For example, the positioning devices may be formed as separate elements that are welded, or otherwise integrally formed together. In further examples, the positioning devices may be integrally formed together as one piece, for example, by an injection molding process. As shown in FIG. 11, the first and second walls 422, 423 are integrally formed together to form an integral one-piece member.

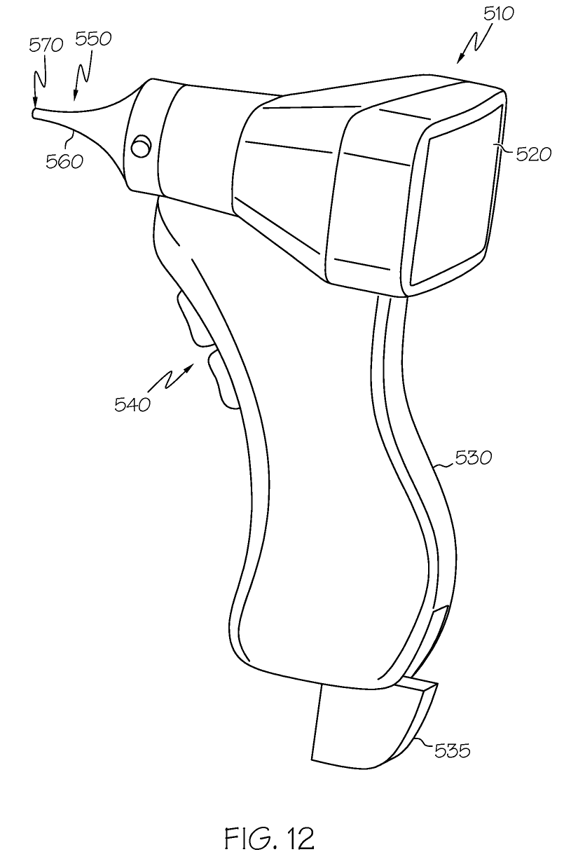

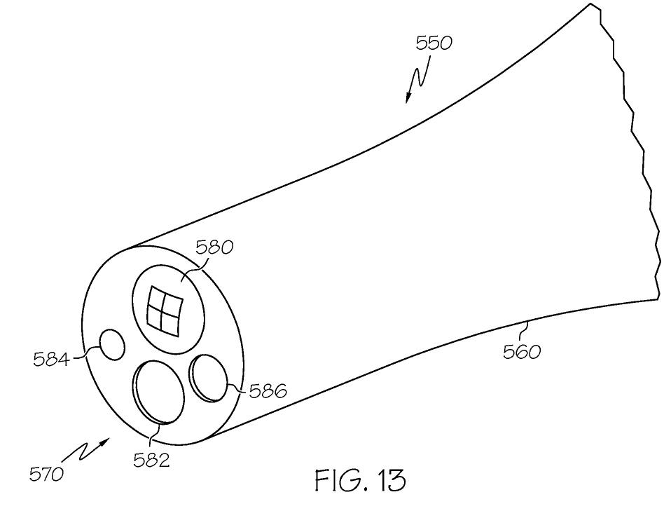

FIGS. 12 and 13 illustrate another example of a detection apparatus 510 in accordance with further aspects of the present invention. As shown, the detection apparatus includes a positioning device 550 including a substantially conical outer surface 560 and an end portion 570. The substantially conical outer surface 560 can facilitate positioning of the end portion 570 within an ear canal of a patient.

As shown in FIG. 13, the end portion 570 can include an image port 582 operatively connected to an electronic view screen 520 configured to display images based on information from the image port 582. The image port 582 can comprise a wide range of structural features to provide information to be displayed on the electronic view screen 520. For example, the image port 582 can be provided with a bundle of optical fibers to transmit visual information to be displayed by the electronic view screen 520. In further examples, the image port 582 may include a sensor configured to transmit electrical signals to be displayed by the electronic view screen 520. For instance, a CCD or CMOS image sensor may be incorporated to transmit information to the electronic view screen 520. The electronic view screen 520 can comprise a liquid crystal display or other electronic display device.

The detection apparatus 510 can also include a light device 586 configured to reflect light from a surface of the ear environment to illuminate the area to be inspected. The light device 586 can be designed to provide a full color spectrum feedback to the image port 582 for display on the electronic view screen 520.

As further illustrated in FIG. 13, the end portion 570 can also include a detection device configured to send and receive signals. A wide variety of detection devices may be used in accordance with aspects of the invention. As shown, in one example, the detection device can comprise an ultrasonic transducer 580 similar or identical to the ultrasonic transducer 25 discussed above. It will be appreciated that other types of detection devices may be incorporated in further examples.

As still further shown in FIG. 13, the end portion 570 can include a fluid outlet port 584 configured to deliver fluid to the ear canal to facilitate transmission of signals from and to the detection device 580. As shown in FIG. 12, the detection apparatus 510 can include a self contained sterile fluid cartridge 535 in fluid communication with the fluid outlet port 584 although an external fluid source may be employed in further examples. A pump may be provided to cause fluid to move from the fluid cartridge 535 to be dispensed through the fluid outlet port 584. FIG. 12 shows the fluid cartridge 535 pivoted to an open position where fluid can be added to the cartridge and then subsequently pivoted to a closed position. In further examples, heat can be applied to a conduit carrying fluid from the cartridge 535 to the fluid outlet port 584 to provide comfortable fluid presentation to the patient. In one example, the conduit may be coiled around one or more components, such as a light source, to use waste heat from the components related to the light device and/or the electronic view screen, for example.

In use, an operator can grasp a handle 530 of the detection apparatus 510. The detection apparatus 510 can then be manipulated such that the end portion 570 of the positioning device 550 is inserted into the ear canal of a patient. The substantially conical outer surface 560 can then be engaged with portions of the ear canal to appropriately position the end portion 570 a distance away from the tympanic membrane. Next, controls 540 can be manipulated to activate the light device 586 to illuminate areas of the ear canal. Light is reflected off the surfaces and received by the image port 582. In one example, the light device 586 can be configured to provide a full color spectrum illumination of the observation areas. Information from the image port 582 is then transmitted for display by the electronic view screen 520. A processor may be designed to provide appropriate image display on the view screen 520. Moreover, examples of the detection apparatus 510 can allow for optional viewing of different information on the view screen. For instance, only certain wavelengths of light may be selected for viewing on the view screen. In a further example, the image port 582 may comprise a heat sensor for displaying thermal information on the view screen 520.

While the detection apparatus 510 is appropriately positioned, the controls 540 can also be manipulated to cause fluid to be pumped from the fluid cartridge 535 through the fluid outlet port 584 to at least partially fill the ear canal with fluid. As mentioned in other examples above, providing the ear canal with an appropriate amount of fluid can facilitate signal transmission from and to the detection device 580. The fluid can comprise, for example, water, saline, and/or other commercially available known fluids, such as AYR-SALINE, NASAL-GEL or VO-SOL, etc.

Next, the controls 540 may be further manipulated to cause signals to be transmitted by the detection device 580. The signals then propagate through the fluid previously delivered to the ear canal. The signals then reflect off area of the ear (e.g., the tympanic membrane) and are subsequently transmitted back to the detection device 580. The detection device can then send signals to a controller. In one example, the signals can indicate if the end portion 570 is located an appropriate distance from locations of the ear (e.g., the tympanic membrane). In another example, if an ultrasonic transducer is used similar to the transducer discussed above, the signals can determine which transducer element is positioned at the most useful beam angle, thereby providing the highest signal to noise ratio. In still another example, the signals can provide information regarding conditions of the ear for display by the electronic view screen 520.

It should be evident that this disclosure is by way of example and that various changes may be made by adding, modifying or eliminating details without departing from the fair scope of teaching contained in this disclosure. In particular, the discussion, equations and methodology presented herein is by way of example only and other variations are contemplated and considered within the scope of the invention.

What is claimed is:

1. A detection apparatus comprising:
a positioning device including a wall with a substantially conical inner surface; and
a detection device configured to send and receive signals and move along the conical inner surface of the wall between a retracted position and a detection position.

2. The detection apparatus of claim 1, wherein the positioning device includes a fluid outlet port for delivering fluid.

3. The detection apparatus of claim 1, wherein the wall includes a substantially conical outer surface.

4. The detection apparatus of claim 1, wherein the wall includes a first wall with a substantially conical outer surface and a second wall with the substantially conical inner surface.

5. The detection apparatus of claim 4, wherein the first and second walls are substantially concentric with respect to one another.

6. The detection device of claim 4, wherein a circumferential fluid conduit is defined by the first and second walls.

7. The detection apparatus of claim 6, wherein the first and second walls are integrally formed together.

8. The detection apparatus of claim 1, wherein the detection device is substantially offset with respect to an axis of the wall in the retracted position and wherein the detection device is substantially aligned with respect to the axis in the detection position.

9. The detection apparatus of claim 1, wherein the detection device comprises an ultrasonic transducer.

10. The detection apparatus of claim 9, wherein the ultrasonic transducer comprises:
a layer of backing material;
a layer of transducer material;
a contact plating layer positioned at least partially between the layer of backing material and the layer of transducer material, the contact plating layer including a convex portion;
an array of transducer elements disposed on the convex portion of the contact plating layer, wherein at least one of the transducer elements is provided with an electrical contact member extending from the contact plating layer; and
an electrical ground member extending from the contact plating layer.

11. The detection apparatus of claim 1, further comprising a viewing lens to visually inspect an area of an ear.

12. A method of using the detection apparatus of claim 1, comprising the steps of:
orienting the positioning device with respect to an ear canal of an ear;
visually inspecting an area of the ear;
moving the detection device along the substantially conical inner surface of the wall from the retracted position to the detection position; and
detecting a condition of the ear.

13. The method of claim 12, further comprising the step of introducing fluid into the ear canal prior to detecting the condition of the ear.

14. An ultrasonic transducer device comprising:
a transducer material layer with a convex surface and a concave surface;
a contact plating layer including a convex portion with an array of transducer elements, wherein the convex portion of the contact plating layer is disposed on the concave surface of the transducer material layer;
an acoustic matching layer including a convex surface facing away from the transducer material layer and a concave surface facing towards the transducer material layer;
a top plating layer at least partially disposed between the convex surface of the transducer material layer and the concave surface of the acoustic matching layer.

15. The ultrasonic transducer device of claim 14, further comprising an electrical ground member positioned in electrical communication with the top plating layer and positioned in electrical isolation from the contact plating layer, and at least one electrical contact member in electrical communication with at least one of the transducer elements.

16. The ultrasonic transducer device of claim 14, further comprising an outer shell including an interior area and an open end in communication with the interior area, wherein the transducer material layer, the contact plating layer, the acoustic matching layer and the top plating layer are at least partially disposed within the interior area of the outer shell.

17. The ultrasonic transducer device of claim 16, wherein a portion of the acoustic matching layer extends through the open end such that at least a portion of the convex surface of the acoustic matching layer is disposed outside of the interior area of the outer shell.

18. The ultrasonic transducer device of claim 16, further comprising a backing material layer disposed within the interior area of the outer shell.

19. The ultrasonic transducer device of claim 14, wherein the maximum outer transverse dimension of the ultrasonic transducer device is less than 5 mm.

20. A detection apparatus comprising,
a positioning device including a substantially conical outer surface and an end portion, the end portion provided with an image port, a light device, and a detection device configured to send and receive signals; and
an electronic view screen configured to display images based on information from the image port.
